(19) United States
(12) Patent Application Publication
(10) Pub. No.: US 2003/0030882 A1
(43) Pub. Date: Feb. 13, 2003

(54) Optical pulse generation

(76) Inventors: Brian Garrett, Newton Abbot (GB); Eric Mark Kimber, Paignton (GB)

Correspondence Address: William M. Lee, Jr, Lee, Mann, Smith, McWilliams, Sweeney & Ohlson, P.O. Box 2786, Chicago, IL, 60690-2786, US

(21) Appl. No.: 09/993,849

(22) Filed: Nov. 26, 2001

Related U.S. Application Data
(60) Provisional application No. 60/312,226, filed on Aug. 13, 2001.

(51) Int. Cl. G02F 1/03; G02F 1/07

(52) U.S. Cl. 359/246; 359/245

(57) ABSTRACT

In the world of high speed communications where the use of return-to-zero modulation format is advantageous, there is a need for being able to exert electrical control, in a relatively simple manner, over the duty cycle of the optical pulses being generated without the undesirable effects of chirp, whilst providing good extinction between pulses. The invention proposes an optical pulse generator and methods of generating and shaping optical pulses using an arrangement of cascaded Mach-Zehnder type interferometers. The pulse generator has a signal generator that produces sinusoidal electrical modulation signals for application to the electrical inputs of cascaded Mach-Zehnder type interferometers. The first Mach-Zehnder type interferometer in the series is responsive to the sinusoidal electrical modulation signal being applied, to generate a series of optical pulses having controllable chirp. Each successive Mach-Zehnder interferometer is responsive to the sinusoidal electrical modulation signal being applied, to shape the series of optical pulses that are input to it from the previous Mach-Zehnder type interferometer, and produce an output train of optical pulses having a duty cycle that is dependant on the waveform of the electrical modulation signal being applied to at least one of the Mach-Zehnder type interferometers. The frequency of the sinusoidal electrical modulation signal that is applied to each Mach-Zehnder type interferometer is substantially the same.

### FIELD OF THE INVENTION

The present invention relates to optical pulse generators, and, in particular, to methods of producing a variable duty cycle optical pulse generator function.

### BACKGROUND OF THE INVENTION

The capability of modulating the intensity of light in optical fiber at high frequencies is essential to the development of very high speed optical communication, advanced sensors, and high frequency signal processing. In particular, narrow optical pulse generation is required for many communications and sensor systems. A variety of techniques have been developed, the most important being direct modulation of a semiconductor diode laser and external modulation of a continuous wave source with an optical modulator. The most widely used devices for the latter approach are based on electro absorption modulators and Mach-Zehnder (MZ) interferometers. At high data rates, it is difficult to generate controlled pulses electrically with such optical modulators.

The MZ interferometer is an optical device wherein input light is split and travels along two continuous paths or arms of the waveguide, and is recombined. The optical paths may be of different lengths so that on recombination the two light beams may interfere either constructively or destructively. To modulate the optical signals in the MZ Interferometer, one or more electro optic modulators comprising electrodes are formed on the waveguide surface in the vicinity of the optical paths. Lithium niobate and gallium arsenide GaAs are examples of electro-optic materials, such that their index of refraction, and thus the optical path length travelled by light passing through the materials, may be varied by the application of an electric field.

A typical modulation format today is Non-Return-to-Zero (NRZ). In this format, for example, a sequential set of ones (1's) is an always “on” condition, and similarly a sequential set of zeros (0's) is an always “off” condition, whereby the power level is less than that for a set of one's but is not necessarily at zero. NRZ applications are typically used on non-dispersion shifted fibre (NDSF), and it is common practice to pre-chirp the modulator in order to achieve pulse compression followed by re-broadening in the transmission fibre, such that after a distance of approximately 80 km there is substantially a net zero penalty with respect to back-to-back measurements. The effect of this is to remove the need for dispersion equalisation over those distances, for example at 10 Gbits/sec.

For the newer types of applications such as ultra long haul and higher bit rates, alternative modulation formats are advantageous such as, for example, Return-to-Zero (RZ) modulation. In the RZ format, any sequential set of ones (1's) is a set of pulses, and any set of zeros (0's) is a set of signals of zero power/amplitude. For RZ there are applications where pre-chirped and unchirped modulation is required. RZ modulation requires the generation of controlled pulses.

One method of attempting to do this is to try to shape the electrical drive waveform applied to the modulators, but this is difficult and expensive to do at high frequencies. Also, a sinusoidal drive waveform can be applied to electro-absorption modulators, which relies on the non-linear transfer function to provide optical pulse narrowing. However, the optical pulses formed by the electro absorption modulator, in general, will have significant chirp which is an undesirable property for near linear return-to-zero (RZ) systems in which signals are encoded in pulses and there is a gap or space between the pulses.

Therefore, there exists a need for generating narrow RZ pulses for modern communication systems with controlled shape and chirp.

Another problem associated with the use of Mach-Zehnder interferometers in some materials is bias drift, for example, due to temperature drift and ageing. In operation, the modulator is typically required to be operated about a particular point in its transmission characteristic, i.e. at a particular bias. Improper bias, however, causes undesirable effects in the transmitted optical signal, such as increased inter-symbol interference in digital systems. In general it is difficult to fabricate a modulator with the proper intrinsic bias, thus the bias is usually set by applying DC voltage. In addition, the required bias is not absolutely fixed; it may vary with time due to external factors, (for example temperature) or internal factors. The phenomenon is termed bias drift. It is necessary to control the bias set point to maintain good extinction and pulse shape.

In the world of high speed communications there is a need for being able to exert electrical control in a relatively simple manner, over the duty cycle (pulse width) of optical pulses which are used to convey data, without the undesirable effects of chirp, whilst providing good extinction between pulses. It is a general objective of the present invention to overcome or significantly mitigate one or more of the aforementioned problems.

### SUMMARY OF THE INVENTION

The invention seeks to provide a method of varying the pulse width of an input optical beam by applying simple sinusoidal drive signals to a cascaded arrangement of Mach-Zehnder type interferometers to modulate phase and amplitude of optical beams with minimal chirp and a means of control to mitigate the effects of bias point drift.

According to a first aspect of the present invention there is provided a method of generating optical pulses with at least two cascaded Mach-Zehnder type interferometers, each Mach-Zehnder type interferometer includes an optical input and a pair of interferometer arms, said method comprising: feeding a continuous wave optical signal into the optical input of a first of the MZIs; modulating both arms of the first Mach-Zehnder type interferometer with a substantially sinusoidal electrical modulation signal, whereby the first Mach-Zehnder type interferometer is caused to output a series of optical pulses each having controllable chirp; feeding the optical output of the first Mach-Zehnder type interferometer into the optical input of the second MZI; modulating both arms of the second Mach-Zehnder type interferometer with a substantially sinusoidal electrical modulation signal, whereby the second Mach-Zehnder type interferometer is caused to output a train of optical pulses having a duty cycle that is dependent on the waveform of the electrical modulation signal being applied to at least one of the Mach-Zehnder type interferometers, wherein the frequency of the substantially sinusoidal electrical modulation signal applied to each Mach-Zehnder type interferometer is substantially the same.

According to a second aspect of the present invention there is provided a method of shaping an optical pulse, said method comprising: inputting an optical beam into a first of a plurality of cascaded Mach-Zehnder type interferometers: applying a substantially sinusoidal electrical modulation signal to the first Mach-Zehnder type interferometer to generate a series of optical pulses having controllable chirp; and applying a substantially sinusoidal electrical modulation signal to the following cascaded Mach-Zehnder type interferometer to shape the series of optical pulses input to following Mach-Zehnder type interferometers to produce an output train of optical pulses having a duty cycle that is dependent on the waveform of the electrical modulation signal being applied to at least one of the Mach-Zehnder type interferometers.

According to a third aspect of the present invention there is provided a method of varying the duty cycle of an output train of optical pulses using a first Mach-Zehnder type interferometer comprising an optical output and an electrical input, and a second Mach-Zehnder type interferometer comprising an optical input and an electrical input, the first and second Mach-Zehnder type interferometers being optically connected in series, with the optical output of the first Mach-Zehnder type interferometer being connected to the optical input of the second Mach-Zehnder type interferometer, said method comprising: applying a substantially sinusoidal electrical modulation signal to said electrical input of said first Mach-Zehnder type interferometer to generate a series of optical pulses having controllable chirp; and applying a substantially sinusoidal electrical modulation signal to the electrical input of the second Mach-Zehnder type interferometer to shape the series of optical pulses that are input to the second Mach-Zehnder type interferometer to produce an output train of optical pulses having a duty cycle that is dependent on the waveform of the substantially sinusoidal electrical modulation signals being applied to at least one of the first and the second Mach-Zehnder type interferometer.

According to a fourth aspect of the present invention there is provided an optical pulse generator comprising: at least two cascaded Mach-Zehnder type interferometers optically connected in series: each Mach-Zehnder type interferometer comprising an optical input, an optical output, and an electrical input; the optical input of a successive Mach-Zehnder type interferometer being connected to the output of the immediately preceding Mach-Zehnder type interferometer in the series; a signal generator which, in use, produces a substantially sinusoidal electrical modulation signal for application to the electrical input of each of the Mach-Zehnder type interferometers, wherein the first Mach-Zehnder type interferometer is responsive to the substantially sinusoidal electrical modulation signal being applied to its electrical input, to generate a series of optical pulses having controllable chirp, and each successive Mach-Zehnder type interferometer is responsive to the substantially sinusoidal electrical modulation being applied to its electrical input, to shape the series of optical pulses that is input to the Mach-Zehnder type interferometer and produce an output train of optical pulses having a duty cycle that is dependent on the waveform of the electrical modulation signal being applied to at least one of the Mach-Zehnder-type interferometers.

According to a fifth aspect of the invention there is provided an optical pulse generator comprising: a first Mach-Zehnder type interferometer comprising an optical output and an electrical input; a second Mach-Zehnder type interferometer comprising an optical input and an electrical input, the first and second Mach-Zehnder type interferometers being optically connected in series with the optical output of the first Mach-Zehnder type interferometer being connected to the optical input of the second Mach-Zehnder type interferometer; one of the first and the second Mach-Zehnder type interferometers has an optical path length shorter than the optical path length of the other Mach-Zehnder type interferometer; an electrical drive signal generator for applying substantially sinusoidal electrical modulation signals to the first and said second Mach-Zehnder type interferometer, wherein the first Mach-Zehnder type interferometer is responsive to the substantially sinusoidal electrical modulation signals being applied to its electrical input, to generate a series of optical pulses having controllable chirp, and the second Mach-Zehnder type interferometer is responsive to the substantially sinusoidal electrical modulation signals being applied to its electrical input, to shape the series of optical pulses that is input to the second Mach-Zehnder type interferometer to produce an output train of optical pulses having a duty cycle that is dependent on the waveform of the electrical modulation signal being applied to at least one of the first and the second Mach-Zehnder type interferometer; and a phase adjuster operable to adjust the phase of the series of optical pulses traveling between the Mach-Zehnder type interferometers so that the phase of the substantially sinusoidal electrical modulation signals applied to the Mach-Zehnder type interferometers is synchronized with the phase of the series of optical pulses input to the Mach-Zehnder type interferometers.

According to a sixth aspect of the invention there is provided an optical telecommunications system comprising: at least one optical pulse generator comprising: at least two cascaded Mach-Zehnder type interferometers optically connected in series: each Mach-Zehnder-type interferometer comprising an optical input, an optical output, and an electrical input; the optical input of a successive Mach-Zehnder type interferometer being connected to the output of the immediately preceding Mach-Zehnder type interferometer in the series; a signal generator which, in use, produces a substantially sinusoidal electrical modulation signal for application to the electrical input of each of the Mach-Zehnder type interferometers, wherein the first Mach-Zehnder type interferometer is responsive to the substantially sinusoidal electrical modulation signal being applied to its electrical input, to generate a series of optical pulses having controllable chirp, and each successive Mach-Zehnder type interferometer is responsive to the substantially sinusoidal electrical modulation being applied to its electrical input, to shape the series of optical pulses that is input to the Mach-Zehnder type interferometer and produce an output train of optical pulses having a duty cycle that is dependent on the waveform of the electrical modulation signal being applied to at least one of the Mach-Zehnder type interferometers; a data-gate for modulating the series of optical pulses being output by the pulse generator to produce an output of optical data pulses; a receiver for receiving the optical data pulses output from the data-gate; and a transmission channel connecting the data gate to the receiver and along which the optical data pulses propagate from the data-gate to the receiver.

According to a seventh aspect of the invention there is provided an optical telecommunications system comprising: at least one optical pulse generator comprising: a first Mach-Zehnder type interferometer comprising an optical output and an electrical input; a second Mach-Zehnder type interferometer comprising an optical input and an electrical input, the first and second Mach-Zehnder type interferometers being optically connected in series with the optical output of the first Mach-Zehnder type interferometer being connected to the optical input of the second Mach-Zehnder type interferometer; one of the first and the second Mach-Zehnder type interferometers has an optical path length shorter than the optical path length of the other Mach-Zehnder type interferometer; an electrical drive signal generator for applying substantially sinusoidal electrical modulation signals to the first and said second Mach-Zehnder type interferometer, wherein the first Mach-Zehnder type interferometer is responsive to the substantially sinusoidal electrical modulation signals being applied to its electrical input, to generate a series of optical pulses having substantially zero frequency chirp, and the second Mach-Zehnder type interferometer is responsive to the substantially sinusoidal electrical modulation signals being applied to its electrical input, to shape the series of optical pulses that is input to the second Mach-Zehnder type interferometer to produce an output train of optical pulses having a duty cycle that is dependent on the waveform of the electrical modulation signal being applied to at least one of the first and the second Mach-Zehnder type interferometer; and a phase adjuster operable to adjust the phase of the series of optical pulses traveling between the Mach-Zehnder type interferometers so that the phase of the substantially sinusoidal electrical modulation signals applied to the second Mach-Zehnder type interferometer is synchronized with the phase of the series of optical pulses input to the second Mach-Zehnder type interferometer; a data-gate for modulating the series of optical pulses being output by the pulse generator to produce an output of optical data pulses; a receiver for receiving the optical data pulses output from the data-gate; and a transmission channel connecting the data-gate to the receiver and along which the optical data pulses propagate from the data-gate to the receiver.

According to an eighth aspect of the invention there is provided an integrated chip comprising: at least two cascaded Mach-Zehnder type interferometers optically connected in series: each Mach-Zehnder type interferometer comprising an optical input, an optical output, and an electrical input; the optical input of a successive Mach-Zehnder type interferometer being connected to the output of a previous Mach-Zehnder type interferometer; wherein the first Mach-Zehnder type interferometer is responsive to a substantially sinusoidal electrical modulation signal being applied to its electrical input, to generate a series of optical pulses having controllable chirp, and each successive Mach-Zehnder type interferometer is responsive to a substantially sinusoidal electrical modulation being applied to its electrical input, to shape the series of optical pulses that is input to the Mach-Zehnder type interferometer and produce an output train of optical pulses having a duty cycle that is dependent on the waveform of the electrical modulation signal being applied to at least one of the Mach-Zehnder-type interferometers.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the invention will now be described by way of example only, with reference to the drawings in which:

FIG. 1 is a simplified schematic diagram of an embodiment of the present invention;

FIG. 2 is a plot showing the time domain output of a light beam produced in accordance with an embodiment of the invention having the Mach-Zehnder type interferometers biased at the maximum transmission point for an input sinusoidal modulation signal of 0.95 Vπpeak (1.9Vπpeak-to-peak);

FIG. 3 is a plot showing the drive signal spectrum for 10 GHz sinusoidal drive pulses used in the embodiment in FIG. 2;

FIG. 4 is a plot showing a time domain output of the embodiment of FIG. 2 where the bias is offset 0.1 Vπ from maximum transmission;

FIG. 5 is a plot showing the presence of side bands at the electrical drive frequency due to the bias offset for the embodiment of FIG. 4;

FIG. 6 is a plot of a time domain output of a second embodiment of the present invention with the Mach-Zehnder type interferometers being biased at the maximum transmission point, and having a modulation signal of 1.1 Vπpeak (2.2Vπpeak-to-peak) applied to the first Mach-Zehnder type interferometer and a modulation signal of Vπpeak (2Vπpeak-to-peak) for the second Mach-Zehnder type interferometer;

FIG. 7 is a plot showing a time domain output of a third embodiment of the present invention with the Mach-Zehnder type interferometers being biased at the maximum transmission point, and having a modulation signal of 0.5 Vπpeak (Vπpeak-to-peak) applied to the first Mach-Zehnder type interferometer and a modulation signal of Vπpeak (2Vπpeak-to-peak) for the second Mach-Zehnder type interferometer;

FIG. 8 is a plot illustrating the effect of phase mismatch for a phase slip of 5 ps in the time domain outputs of the first and second Mach-Zehnder type interferometer, for a 10 GHz sinusoidal electrical drive signal; and

FIG. 9 is a simplified schematic diagram of a cross-section through a Mach-Zehnder type interferometer of a preferred embodiment in accordance with the invention.

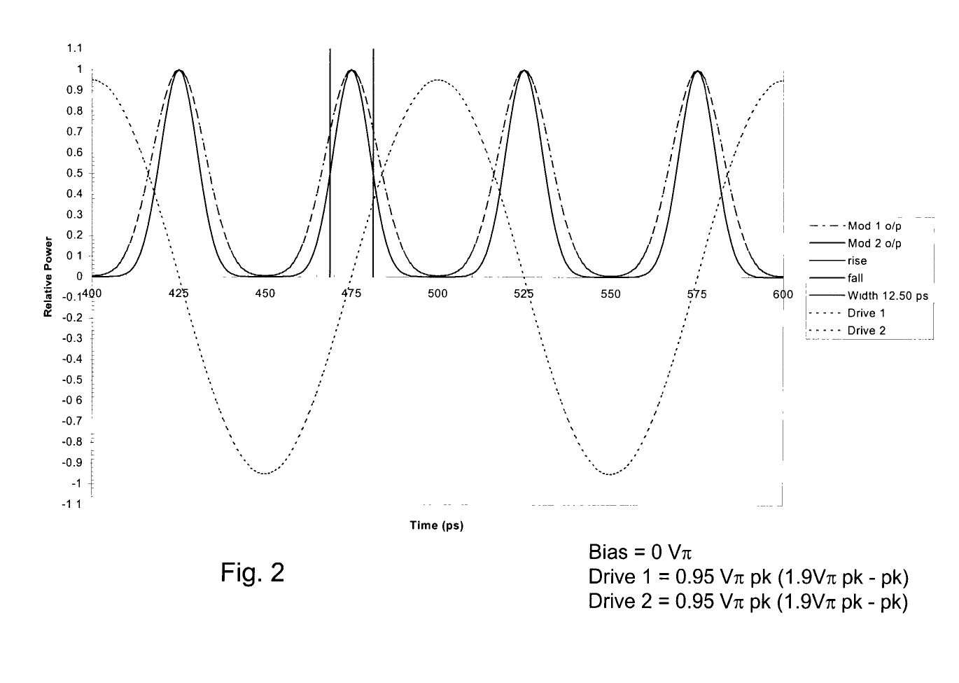

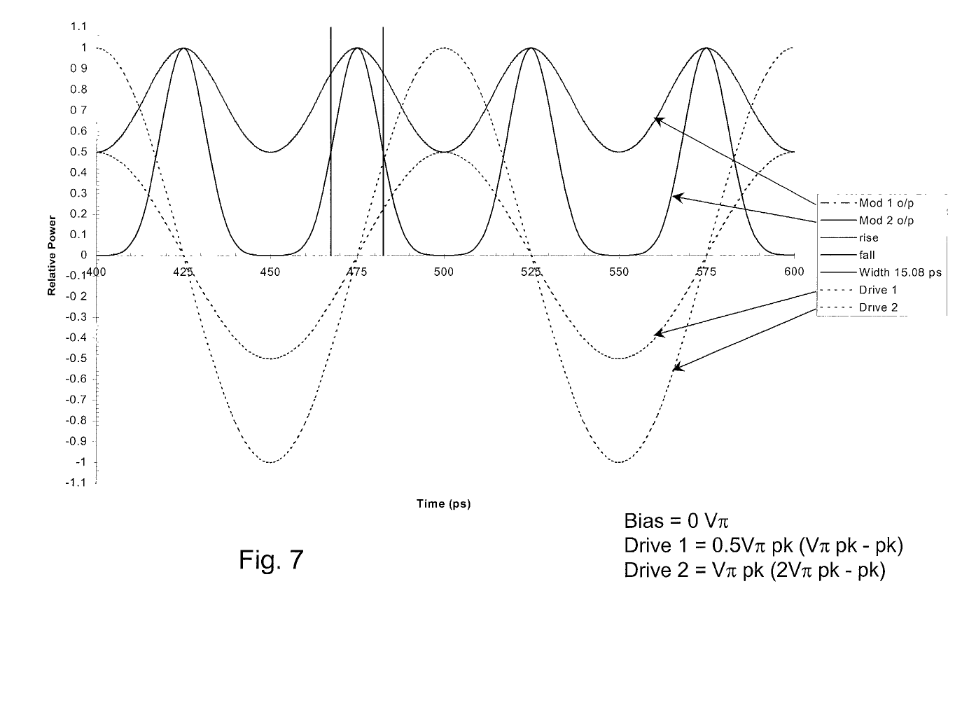

The terms “Mod 1 o/p” and “Mod 2 o/p” used in the legends of FIGS. 2, 4, 6, 7 and 8, denote a series of optical pulses output from the first and second Mach-Zehnder type interferometers respectively. The terms “Drive 1” and “Drive 2” in these legends refer to the modulation signals applied to the first and second Mach-Zehnder type interferometer respectively. The terms “rise” and “fall” in the legends refer to the points at half the maximum power of an optical pulse output from the second Mach-Zehnder type interferometer along the rise and fall, respectively, of the pulse waveform, and the term “width” denotes the pulse width in picoseconds measured between the rise and fall of the optical pulse output from the second Mach-Zehnder type interferometer.

### DETAILED DESCRIPTION OF THE PREFERRED EMBODIMENTS

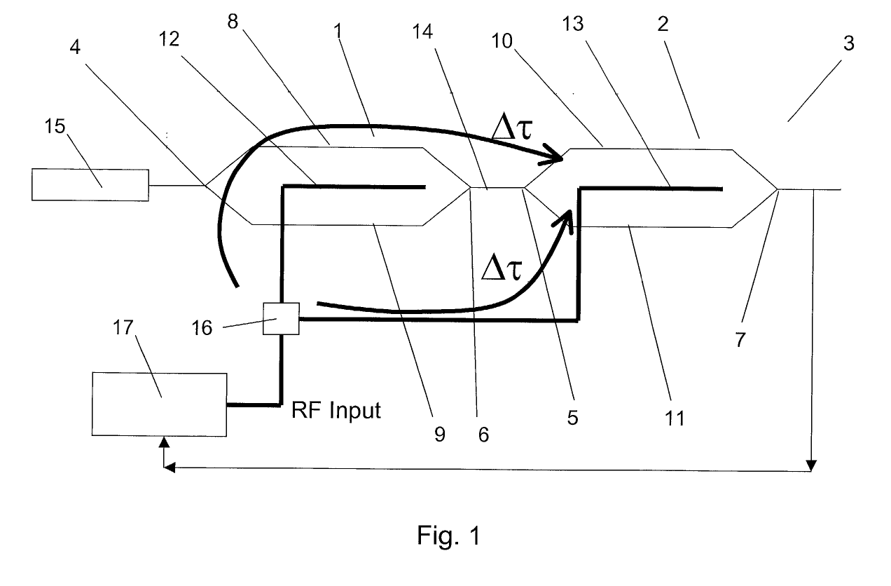

FIG. 1 shows a simplified schematic view of a controllable pulse generator that comprises a pair of Mach-Zehnder type interferometers 1,2 formed in a cascaded fashion (in series) on an integrated GaAs chip 3. Each Mach-Zehnder type interferometer has a beam splitter 4,5 such as a multimode interferometric coupler, and a combiner 6,7, between which lie two interferometer arms 8,9,10,11. Each pair of interferometer arms 8,9,10,11 has associated RF transmission lines 12,13, as well as an electro optic modulator comprising a pair of electrodes and a pair of waveguides. The waveguides are formed on the surface of the chip 3 using known techniques. Each RF transmission line 12,13 comprises a pair of electrodes, one disposed on each side of an associated interferometer arm 8,9,10,11. The output port of the first Mach-Zehnder type interferometer is an optical waveguide 14, a portion of which forms the input port of the second Mach-Zehnder type interferometer.

Light emitted from a continuous wave laser 15 is input to the first of the cascaded Mach-Zehnder type interferometers 1, where it is split in to two equal components that travel along the interferometer arms 8,9. At the end of the arms the two light beams recombine in the combiner 6. The recombined light beam then travels through a waveguide 14 and is input to the second Mach-Zehnder type interferometer 2 where the light beam is again split into two equal components that travel along the interferometer arms 10,11 of the second Mach-Zehnder type interferometer 2. The two light beams are recombined in the combiner 7 at the end of the interferometer arms 10,11.

The RF signal, a time varying voltage, produces an electric field in the chip substrate. The electric field, due to the well-known electro optic effect, effectively changes the relevant indices of refraction, and thus the optical path lengths of the interferometer arms. Modulation occurs because the relative phase of the optical signals at the combiners varies according to the instantaneous amplitude of the RF drive signals. The varying phase relationship between the light beams traveling in the interferometer arms results in a varying amplitude (intensity) of the recombined light beam at the output port of the MZ interferometer. The exact shape of the RF drive signal applied is determined by the shape of the optical pulse required from the generator and by the response of the modulator to an applied voltage.

When zero voltage is applied to the RF electrodes the light beams recombine in phase with each other at the combiner. The light beam at the output of the second MZ interferometer is thus essentially similar to the light beam input to the first MZ interferometer. If a DC Voltage is supplied to the RF electrodes, such that due to the change in refractive index the effective path lengths of the light beams differs by a multiple of λ/2, the light beams when recombined are 180° out of phase. In this case, the amplitudes of the light beams cancel each other out and a zero amplitude light beam is produced at the corresponding MZ interferometer output, i.e. no light.

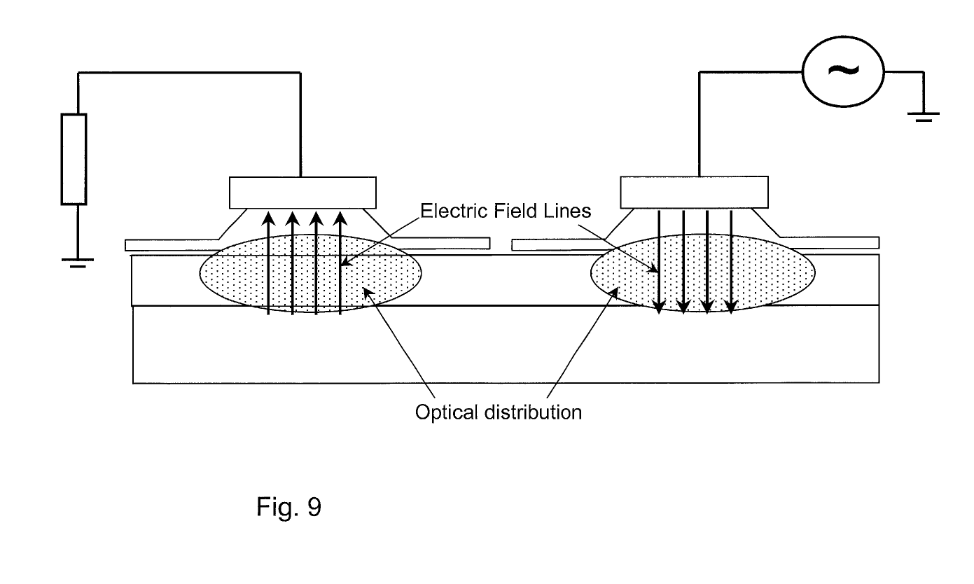

The electrodes are arranged around each Mach-Zehnder type interferometer so that the electric field generated during use, goes down through one of the interferometer arms in a first direction and comes up through the other interferometer arm in an opposite direction. FIG. 9 shows a simplified cross-sectional view of a Mach-Zehnder type interferometer illustrating the electric field lines generated in use. When an electrical drive signal is applied to the electrodes, it causes opposite phase changes to occur to the optical beams traveling in the two interferometer arms. Thus, effectively the phase of each of the two optical beams traveling through the interferometer arms is caused to go into anti-phase with respect to the other. To operate the Mach-Zehnder type interferometers at maximum transmission, voltage is applied to the electrodes which causes the phase to advance in one arm and retard in the other arm. The net difference in phase is seen when the optical beam is re-combined. If the phase change in both arms is exactly the same but with opposite sign, then there is substantially zero chirp.

The modulators are driven by a drive control circuit 17 that outputs a RF drive signal to a power splitter 16. The drive signal, which is phase matched to the optical power of the Mach-Zehnder type interferometers 1,2, is split into two RF signals by the power splitter 16, each signal being applied to a modulator. Since the Mach-Zehnder type interferometers 1,2 are formed on the same chip 3, two forms of phase matching are required. The first type is for matching the electrical group velocity of the electrode to the optical group velocity on the waveguide. This way the two velocities may be kept in phase along the waveguide. The second type of phase matching needed is for making sure that the electrical drive signal applied to the second Mach-Zehnder type interferometer is applied at the right time, so as to be in phase with the optical pulse arriving from the first Mach-Zehnder type interferometer. This is shown in FIG. 1 by the paths labelled Δτ.

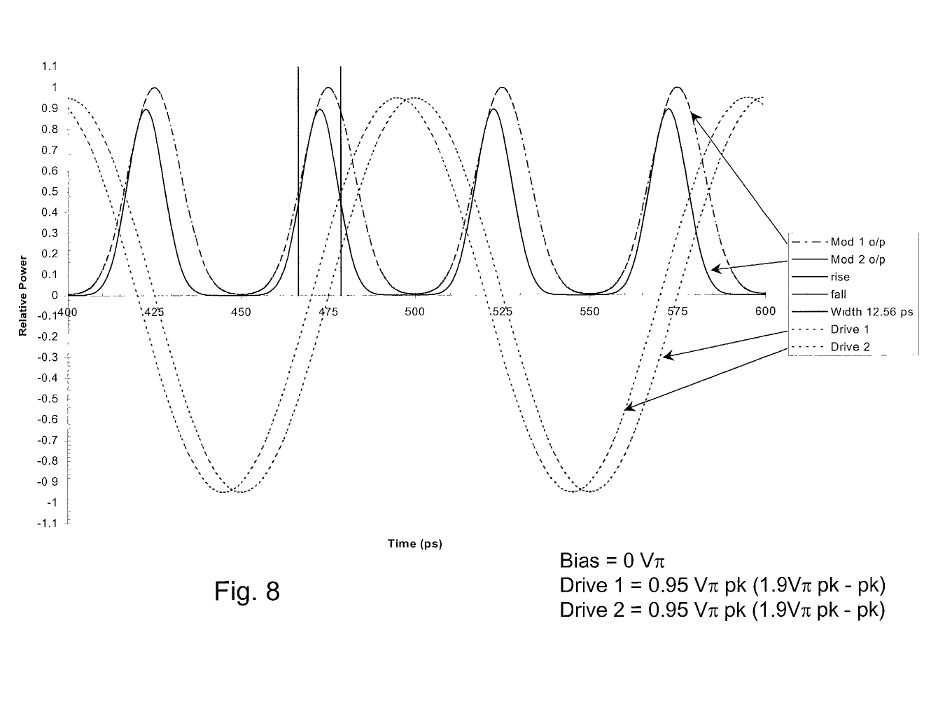

FIG. 8 illustrates the effect of phase slip whereby a time domain output is shown for a phase mismatch of 5 ps (picoseconds) for a 10 GHz sinusoidal electrical drive signal. The resulting time domain output of the second Mach-Zehnder type interferometer has a reduced intensity and reduced duty cycle.

As the optical beams pass through the interferometer arms 8,9,10,11, the RF signal is applied to the electrodes to modulate the optical beams as required.

To generate a +/−π phase change, the optical beam travelling along one of the interferometer arms is changed by +/−π/2, and the optical beam in the other arm is changed by −/+π/2, so that the net difference in phase will be +/−π. This technique allows frequency doubling, for example, modulating with a 10 GHz sinusoidal drive signal will produce optical pulses every half cycle, and so frequency is doubled.

The RF signal applied to the electrodes is a sinusoidal electrical drive signal, which may be adjusted in order to be applied in differing ratios to the two Mach-Zehnder type interferometers. Using this technique the duty cycle of the output optical pulse may be controlled.

To control the bias voltage of the modulators, the output beam from the second MZ interferometer may be monitored, for example, by an optical receiver (not illustrated) which feedbacks information relating to characteristics of the output beam to a bias control circuit 17. Alternatively, monitoring taps, i.e. tap waveguides, may be applied to the first and/or second Mach-Zehnder type interferometer. The bias control circuit is essentially a feedback loop which compares the characteristics of the output light beam against pre-set values and then adjusts the bias voltage (DC Voltage) being applied to the modulators according to the results of the comparison.

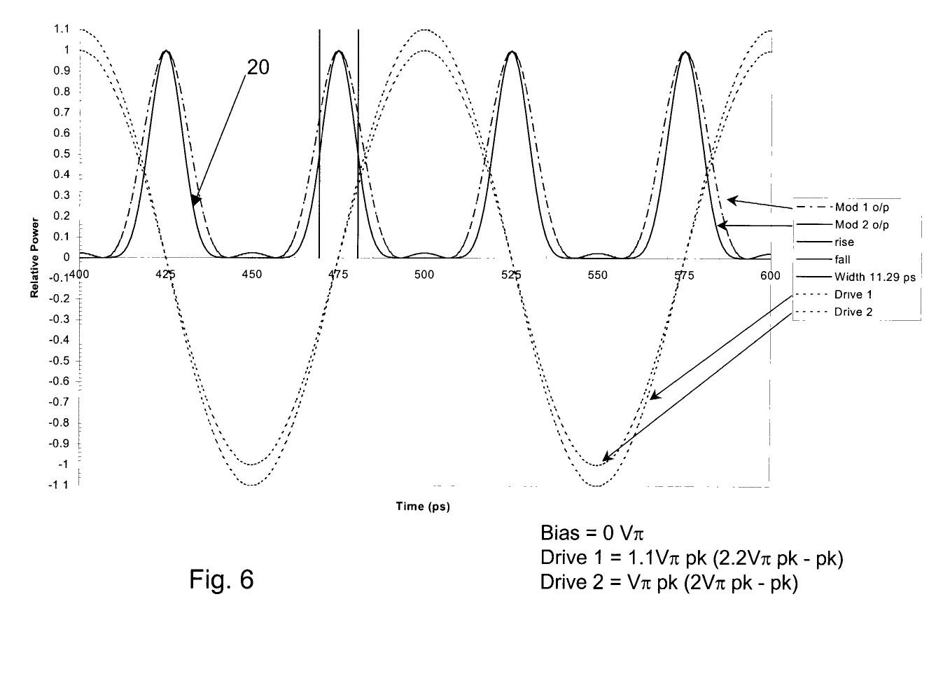

Biasing the modulation enables adjustments of the static transmission point of the modulator to suit the drive system being employed. The static bias of the modulator can be set to any point on the transmission curve and is independent of the RF drive electrode. FIGS. 6,7 and 8 show the time domain output achievable for such an arrangement, where the Mach-Zehnder type interferometers are biased at the maximum transmission point, and RF drive modulation signals as described in the figures are applied to the Mach-Zehnder type interferometers. It can be seen that the time domain output from such an arrangement maintains a good extinction ratio and pulse width control.

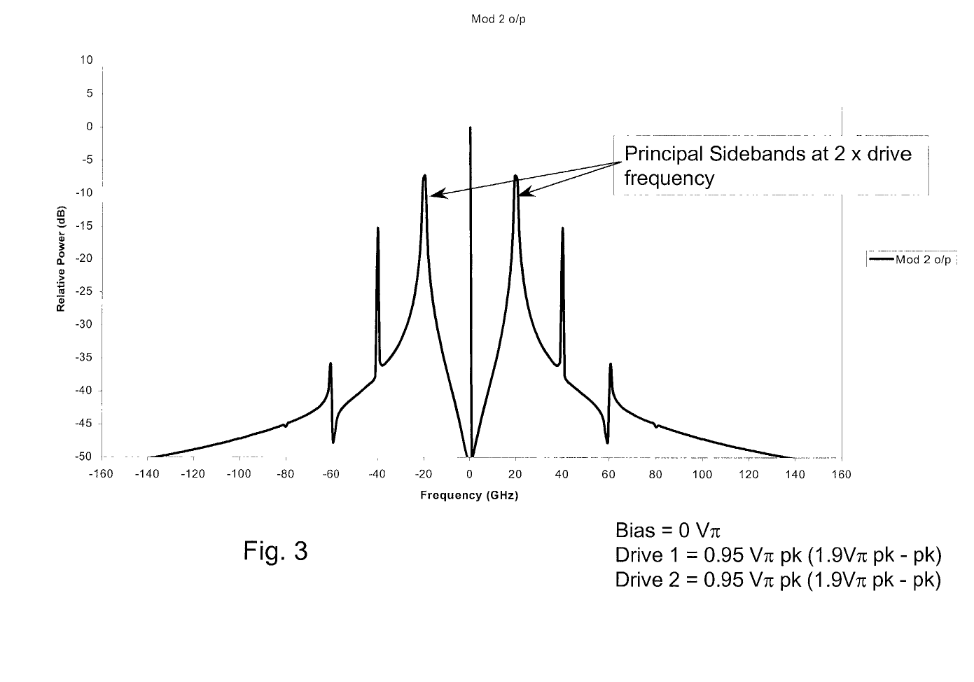

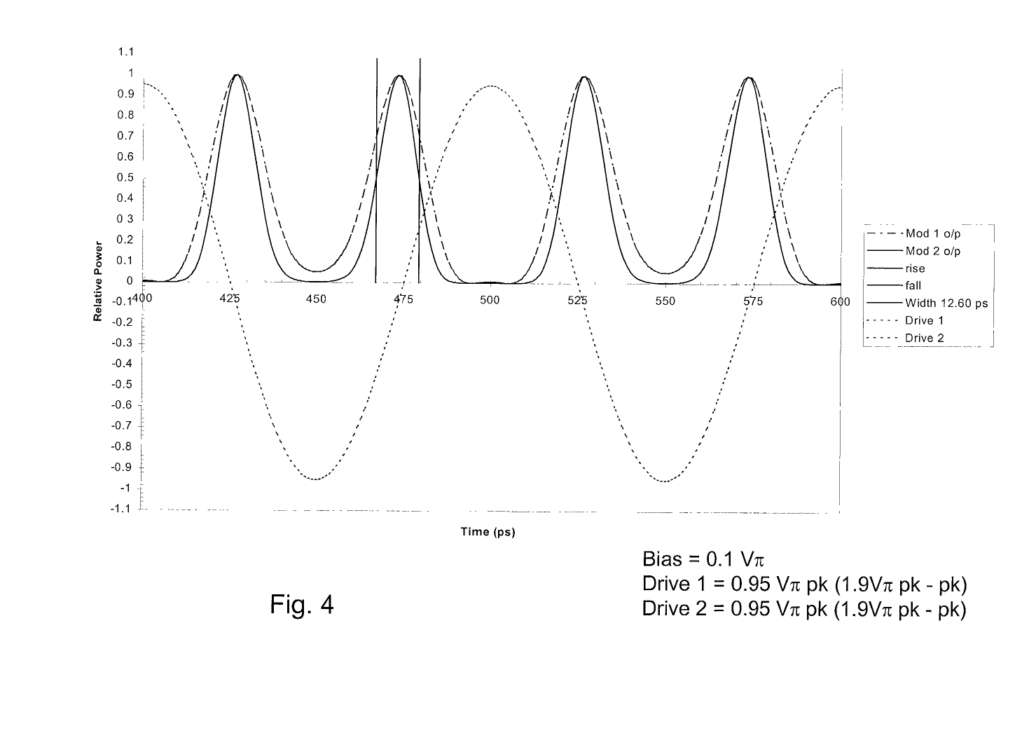

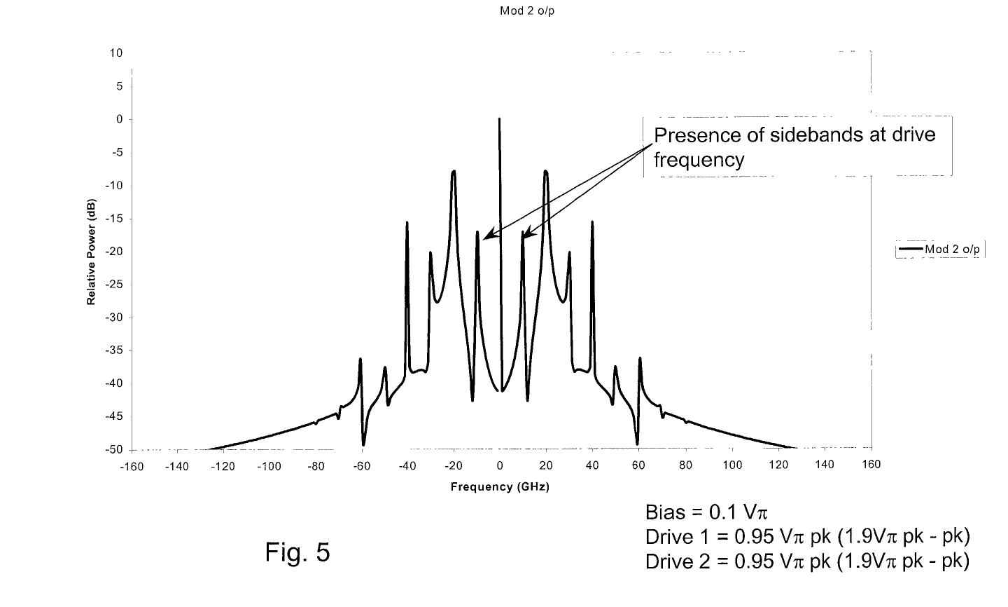

In a preferred embodiment for narrowing the duty cycle of an optical pulse beam the following method is employed. Separate RF drive signals are applied to the Mach-Zehnder type interferometers to allow independent control of pulse widths (duty cycle) and extinction. Typically, the pulse width, extinction ratio and amplitude combination are controlled by the relative amplitudes and phases of the electrical drive signals of the first and second Mach-Zehnder type interferometers. This can be seen in FIGS. 6, 7 and 8. The first Mach-Zehnder type interferometer is biased at maximum transmission (e.g. close to zero volts) and modulated with a sinusoidal electrical drive signal. The drive signal is applied such that the resultant optical field suffers zero (or minimal) chirp. Providing the electrical drive zero is aligned to the maximum transmission point then pulses are generated on each half cycle of the electrical drive, (for example at 10 GHz sinusoidal drive, pulses are generated at 20 GHz), and the resulting spectrum will contain substantially no frequency components at the electrical drive frequency. FIG. 2 shows a time domain output for Mach-Zehnder type interferometers driven in this manner, and FIG. 3 shows the corresponding signal spectrum from which the frequency components at the electrical drive frequency are minimized. There are no side bands (or peaks) to be seen at the ±10 GHz points on the plot. However, if the electrical drive has a bias offset to one side of the maximum transmission point then the spectrum will contain frequency components of the electrical drive frequency, whose magnitude increases as the offset increases. FIG. 4 shows a time domain output for the Mach-Zehnder type interferometers modulators driven with a bias offset of 0.1Vπ, and FIG. 5 shows the corresponding signal spectrum from which the frequency components at the electrical drive frequency are seen. Side bands at the ±10 GHz points on the spectrum are clearly visible.

By monitoring the presence of the frequency component of the electrical drive frequency at the Mach-Zehnder type interferometer output, and minimizing this through making the necessary adjustment to the bias voltage of the drive signal, alignment can be maintained.

The second Mach-Zehnder type interferometer is also biased at the maximum transmission point. The pulse width is then controlled by the product of the two modulation functions. This arrangement allows, for example, for the first Mach-Zehnder type interferometer to be overdriven (i.e. greater than the Vπpeak (2Vπpeak-to-peak) point) which would normally result in a reduced pulse width but with additional pulses of lower magnitude to appear in between the required pulses. The second Mach-Zehnder type interferometer can be driven to its Vπpeak (2Vπpeak-to-peak) point (zero transmission) in order to remove the secondary pulses giving good extinction and allowing significant control over the pulse width (duty cycle). Operating the Mach-Zehnder type interferometers in this way allows the duty cycle to be controlled. FIG. 6 shows a plot of a time domain output illustrating this arrangement, where a drive signal of 1.1Vπpeak (2.2Vπpeak-to-peak) is applied to the first Mach-Zehnder type interferometer and a drive signal of Vπpeak (2Vπpeak-to-peak) is applied to the second Mach-Zehnder type interferometer. The additional pulses of lower magnitude, resulting from the first modulator being overdriven, are visible in the plot at the 400, 450, 500, 550 and 600 ps (picosecond) points. The output achieved by driving the second modulator at its Vπpeak (2Vπpeak-to-peak) point resulting in the removal of the secondary pulse, is also illustrated in FIG. 6, where the graph 20 is representative of the output achieved showing good extinction and significant narrowing of pulse width.

Instead of biasing both first and second Mach-Zehnder type interferometers to the maximum transmission point, another method would be to bias the first Mach-Zehnder type interferometer to the zero transmission point and the second Mach-Zehnder type interferometer to the maximum transmission point. This produces suppressed carrier modulation, whereby the carrier waveform of the optical pulse will be absent, and the spectral width of the sidebands will be reduced. Therefore, suppressed carrier modulation is a way of reducing the spectral width requirement for the same information content of an optical pulse train.

There are three ways of implementing electrical phase control for the pulse generator. The first is applying independent control, using independent RF signal generators for each Mach-Zehnder type interferometer to give independent control over amplitude. Suitable circuitry may be used with the Mach-Zehnder type interferometers to control the phase between the two independent modulation signals generated by the RF signal generators that are applied to the Mach-Zehnder type interferometers.

The second way is to use a single RF signal generator, the output of which is split between the first and the second Mach-Zehnder type interferometer as already mentioned above. The ratio of the split between the Mach-Zehnder type interferometers may be controlled to give a different amplitude to each of the two Mach-Zehnder type interferometers. Alternatively, the ratio of the split between the Mach-Zehnder type interferometers may be fixed (termed a “fixed split”) and a means for varying the amplitude and/or phase may be introduced after the split. Another technique is to vary the Mach-Zehnder type interferometer interaction length, i.e. the optical path lengths of the two Mach-Zehnder type interferometers would not be identical. For example, if one of the Mach-Zehnder type interferometers was shorter than the other, then although the same drive signal is applied to the modulators of the two Mach-Zehnder type interferometers, the Vπ for the shorter Mach-Zehnder type interferometer will be larger resulting in a different split ratio drive.

A third way is to use a combination of RF electrical phase adjustment and/or optical path length adjustment. For the two Mach-Zehnder type interferometers formed on the chip there is a time of flight that the optical beam takes to get from the output of one Mach-Zehnder type interferometer to the input of the other. One method of compensating for this effect is to try to build the electrical path so that it is exactly matched to offset the time of flight. Another method would be to introduce some form of phase adjustment and to use a control circuit to align the optical beams traveling through the two Mach-Zehnder type interferometers. Alternatively, a means for adjusting the optical group delay may be added, for example another contact, which would then be used to adjust the index and give control of the optical group delay.

Electrical control over the duty cycle of the optical pulse train achieved by the above described arrangements is typically over 15% to 40%. However, the arrangements described herein can be modified to include a number of cascaded MZ interferometers with appropriately biased electrical drive to control duty cycle and extinction. The arrangement and methods of driving the pulse generator described herein allow the duty cycle of the optical pulse train to be controlled relatively simply whilst employing simple sinusoidal electrical drive signals. The method of driving the pair of MZ interferometers by maintaining electrical phase alignment and varying amplitude allows a significant degree of independence between controlling pulse width at moderate duty cycles whilst maintaining good pulse extinction.

The techniques described herein allow the generation of soliton waveforms as the output optical pulses.

Instead of applying separate RF drive signals to both Mach-Zehnder type interferometers the same RF signal may be applied to both Mach-Zehnder type interferometers. The optical path length will then be arranged to be equal to an interval number of bit periods to ensure electrical/optical phase synchronization. Modulation is then bit rate dependent.

If bit rate independent modulation is required, then the RF signal is arranged to be phase matched with the optical pulses between the two modulators, such that a single electrical drive is applied to the pair of modulators.

If tighter optical pulses need to be generated, i.e. a lower duty cycle is required for a pulse train, then more than two Mach-Zehnder type interferometers may be cascaded using the technique described above. An example of an application where tight optical pulses would be required is for Optical Time Domain Multiplexing (OTDM). Here a generated optical pulse train may be multiplexed in the time domain by a factor of four, or even higher. In this type of application the pulses of the optical pulse train need to be extremely narrow, because when the optical pulse train is multiplexed, the pulses should not overlap. This technique allows a 10 Gb optical pulse train with very narrow pulses to be multiplexed to 40 Gb or higher.

Although the invention has been shown and described with respect to a best mode embodiment thereof, it should be understood by those skilled in the art that the foregoing and various other changes, omissions and additions in the form and detail thereof may be made therein without departing from the scope of the invention as claimed.

We claim:

1. A method of generating optical pulses with at least two cascaded Mach-Zehnder type interferometers, each Mach-Zehnder type interferometer includes an optical input and a pair of interferometer arms, said method comprising:
feeding a continuous wave optical signal into the optical input of a first of the MZIs;
modulating both arms of the first Mach-Zehnder type interferometer with a substantially sinusoidal electrical modulation signal, whereby the first Mach-Zehnder type interferometer is caused to output a series of optical pulses each having controllable chirp;
feeding the optical output of the first Mach-Zehnder type interferometer into the optical input of the second MZI;
modulating both arms of the second Mach-Zehnder type interferometer with a substantially sinusoidal electrical modulation signal, whereby the second Mach-Zehnder type interferometer is caused to output a train of optical pulses having a duty cycle that is dependent on the waveform of the electrical modulation signal being applied to at least one of the Mach-Zehnder type interferometers,
wherein the frequency of the substantially sinusoidal electrical modulation signal applied to each Mach-Zehnder type interferometer is substantially the same.

2. A method according to claim 1, wherein the substantially sinusoidal electrical modulation signals applied to each Mach-Zehnder type interferometer comprise substantially the same waveform.

3. A method according to claim 1, wherein both arms of the Mach-Zehnder type interferometers are modulated in anti-phase with a substantially sinusoidal electrical modulation signal, whereby the Mach-Zehnder type interferometers are caused to output a train of optical pulses having substantially zero frequency chirp.

4. A method according to claim 1, wherein the Mach-Zehnders type interferometers each comprise an electro-optic material through which optical beams may propagate, and said method further comprises:
electro-optically biasing the material propagating the optical beams through at least one of the Mach-Zehnder type interferometers thereby changing a characteristic of the optical beams.

5. A method as claimed in claim 4, wherein the step of electro-optically biasing comprises:
applying a bias voltage to at least one of the Mach-Zehnder type interferometers so that the optical pulses are symmetric and substantially identical and so that the extinction ratio is maximised;
monitoring the train of optical pulses output from the last of the Mach-Zehnder type interferometers; and
adjusting the level of bias voltage being applied to substantially maintain the symmetry of the optical pulses and their homogeneity and to maximize the extinction ratio.

6. A method according to claim 1, further comprising:
biasing the modulators of each of the Mach-Zehnder type interferometers to substantially peak transmission using electrical drive signals so that the optical pulses output from the cascaded Mach-Zehnder type interferometers are symmetric about the operating point and have substantially zero frequency chirp.

7. A method according to claim 1, further comprising:
biasing the modulator of the first Mach-Zehnder type interferometer to substantially zero transmission using an electrical drive signal; and
biasing the modulator of the second Mach-Zehnder type interferometer to substantially peak transmission using an electrical drive signal to suppress the optical carrier of the output optical pulses.

8. A method according to claim 1, further comprising:
biasing the modulator of the first Mach-Zehnder type interferometer to substantially zero transmission using an electrical drive signal to suppress the optical carrier of the output optical pulses.

9. A method according to claim 1, further comprising:
biasing the modulator of the first Mach-Zehnder type interferometer to substantially quadrature point using an electrical drive signal; and
biasing the modulator of the second Mach-Zehnder type interferometer to substantially peak transmission using an electrical drive signal to cause the train of optical pulses output from the cascaded Mach-Zehnder type interferometers to have a controlled amount of chirp.

10. A method according to claim 1, further comprising:
biasing the modulators of each of the Mach-Zehnder type interferometers to quadrature point using electrical drive signals.

11. A method according to claim 1, further comprising:
generating a substantially sinusoidal electrical modulation signal using a signal generator;
splitting the substantially sinusoidal electrical modulation signal into at least two substantially sinusoidal electrical modulation signals using a power splitter; and
applying the respective substantially sinusoidal electrical modulation signals to the Mach-Zehnder type interferometers.

12. A method according to claim 11, wherein the substantially sinusoidal electrical modulation signal is split according to a pre-determined fixed ratio.

13. A method according to claim 11, wherein the step of splitting comprises:
splitting the substantially sinusoidal electrical modulation signal in a variable ratio set by a split ratio controller associated with the power splitter.

14. A method according to claim 11, further comprising:
varying the ratio of splitting the substantially sinusoidal electrical modulation signals to produce substantially sinusoidal electrical modulation signals that vary one or more of: amplitude and phase of the optical beam, and optical pulses, as desired.

15. A method according to claim 11, further comprising:
adjusting the phase of the series of optical pulses traveling between the Mach-Zehnder type interferometers using a phase-controllable waveguide located between the Mach-Zehnder type interferometers so that the phase of the substantially sinusoidal electrical modulation signals applied to the Mach-Zehnder type interferometers is synchronized with the phase of the series of optical pulses input to the Mach-Zehnder type interferometers.

16. A method according to claim 11, further comprising:
adjusting the phase of the series of optical pulses traveling between the Mach-Zehnder type interferometers using an electrical modulation signal delay line located between the Mach-Zehnder type interferometers so that the phase of the substantially sinusoidal electrical modulation signals applied to the Mach-Zehnder type interferometers is synchronized with the phase of the series of optical pulses input to the Mach-Zehnder type interferometers.

17. A method of shaping an optical pulse, said method comprising:
inputting an optical beam into a first of a plurality of cascaded Mach-Zehnder type interferometers:
applying a substantially sinusoidal electrical modulation signal to the first Mach-Zehnder type interferometer to generate a series of optical pulses having controllable chirp; and
applying a substantially sinusoidal electrical modulation signal to the following cascaded Mach-Zehnder type interferometer to shape the series of optical pulses input to following Mach-Zehnder type interferometers to produce an output train of optical pulses having a duty cycle that is dependent on the waveform of the electrical modulation signal being applied to at least one of the Mach-Zehnder type interferometers.

18. A method of varying the duty cycle of an output train of optical pulses using a first Mach-Zehnder type interferometer comprising an optical output and an electrical input, and a second Mach-Zehnder type interferometer comprising an optical input and an electrical input, the first and second Mach-Zehnder type interferometers being optically connected in series, with the optical output of the first Mach-Zehnder type interferometer being connected to the optical input of the second Mach-Zehnder type interferometer, said method comprising:
applying a substantially sinusoidal electrical modulation signal to said electrical input of said first Mach-Zehnder type interferometer to generate a series of optical pulses having controllable chirp; and
applying a substantially sinusoidal electrical modulation signal to the electrical input of the second Mach-Zehnder type interferometer to shape the series of optical pulses that are input to the second Mach-Zehnder type interferometer to produce an output train of optical pulses having a duty cycle that is dependent on the waveform of the substantially sinusoidal electrical modulation signals being applied to at least one of the first and the second Mach-Zehnder type interferometer.

19. An optical pulse generator comprising:
at least two cascaded Mach-Zehnder type interferometers optically connected in series:
each Mach-Zehnder type interferometer comprising an optical input, an optical output, and an electrical input; the optical input of a successive Mach-Zehnder type interferometer being connected to the output of the immediately preceding Mach-Zehnder type interferometer in the series;
a signal generator which, in use, produces a substantially sinusoidal electrical modulation signal for application to the electrical input of each of the Mach-Zehnder type interferometers,
wherein the first Mach-Zehnder type interferometer is responsive to the substantially sinusoidal electrical modulation signal being applied to its electrical input, to generate a series of optical pulses having controllable chirp, and each successive Mach-Zehnder type interferometer is responsive to the substantially sinusoidal electrical modulation being applied to its electrical input, to shape the series of optical pulses that is input to the Mach-Zehnder type interferometer and produce an output train of optical pulses having a duty cycle that is dependent on the waveform of the electrical modulation signal being applied to at least one of the Mach-Zehnder-type interferometers.

20. An optical pulse generator according to claim 19, further comprising:
a signal splitter for splitting the substantially sinusoidal electrical modulation signal, according to a fixed split ratio, into secondary substantially sinusoidal electrical modulation signals, each to be applied to one of the Mach-Zehnder type interferometers.

21. An optical pulse generator according to claim 20, wherein the signal splitter is adapted to be controllable so that the splitting ratio of the substantially sinusoidal electrical modulation signal is variable.

22. An optical pulse generator according to claim 21, wherein the signal splitter is adapted to control the splitting ratio of the substantially sinusoidal electrical modulation signal with respect to amplitude of the substantially sinusoidal electrical modulation signal.

23. An optical pulse generator according to claim 19, further comprising:
a bias control circuit for biasing each of the Mach-Zehnder type interferometers to substantially peak transmission such that the duty cycle of the train of optical pulses output from the cascaded Mach-Zehnder type interferometers is controllable by an amount in the range 15% to 40%.

24. An optical pulse generator according to claim 19, further comprising:
a bias control circuit for biasing the first Mach-Zehnder type interferometer to substantially zero transmission and for biasing the second Mach-Zehnder type interferometer to substantially peak transmission such that the optical carrier of the optical pulses is suppressed.

25. An optical pulse generator according to claim 19, further comprising:
a bias control circuit for biasing each of the Mach-Zehnder type interferometers to quadrature point.

26. An optical pulse generator according to claim 19, further comprising:
a phase adjuster operable to adjust the phase of the series of optical pulses traveling between the Mach-Zehnder type interferometers so that the phase of the substantially sinusoidal electrical modulation signals applied to the Mach-Zehnder type interferometers is synchronized with the phase of the series of optical pulses input to the Mach-Zehnder type interferometers.

27. An optical pulse generator according to claim 26, wherein the phase adjuster is a phase-controllable waveguide.

28. An optical pulse generator according to claim 26, wherein the phase adjuster is an electrical modulation signal delay line.

29. An optical pulse generator according to claim 19, wherein at least one of the Mach-Zehnder type interferometers has an optical path length shorter than the optical path length of the other Mach-Zehnder type interferometer or others.

30. An optical pulse generator according to claim 19, further comprising:
a bias control circuit for maintaining bias alignment of at least one of the Mach-Zehnder type interferometers, and being electrically coupled to the electrical input of at least one of the Mach-Zehnder type interferometers, and being optically coupled to the optical output of at least one of the Mach-Zehnder type interferometers, said bias control circuit responsive to the function of the output train of optical pulses to apply a biasing electrical signal to at least one of the Mach-Zehnder type interferometers.

31. An optical pulse generator according to claim 19, wherein at least one of the Mach-Zehnder type interferometers is adapted to modulate a phase of the optical pulses.

32. An optical pulse generator according to claim 19, wherein the signal generator is adapted to supply the substantially sinusoidal electrical modulation signals to the electrical input of some of the Mach-Zehnder type interferometers; and
the optical pulse generator further comprises:
further signal generators for synchronously supplying, in use, substantially sinusoidal electrical modulation signals to the electrical inputs of the remainder of the Mach-Zehnder type interferometers.

33. An optical pulse generator comprising:
a first Mach-Zehnder type interferometer comprising an optical output and an electrical input;
a second Mach-Zehnder type interferometer comprising an optical input and an electrical input, the first and second Mach-Zehnder type interferometers being optically connected in series with the optical output of the first Mach-Zehnder type interferometer being connected to the optical input of the second Mach-Zehnder type interferometer;
one of the first and the second Mach-Zehnder type interferometers has an optical path length shorter than the optical path length of the other Mach-Zehnder type interferometer;
an electrical drive signal generator for applying substantially sinusoidal electrical modulation signals to the first and said second Mach-Zehnder type interferometer,
wherein the first Mach-Zehnder type interferometer is responsive to the substantially sinusoidal electrical modulation signals being applied to its electrical input, to generate a series of optical pulses having controllable chirp, and the second Mach-Zehnder type interferometer is responsive to the substantially sinusoidal electrical modulation signals being applied to its electrical input, to shape the series of optical pulses that is input to the second Mach-Zehnder type interferometer to produce an output train of optical pulses having a duty cycle that is dependent on the waveform of the electrical modulation signal being applied to at least one of the first and the second Mach-Zehnder type interferometer; and
a phase adjuster operable to adjust the phase of the series of optical pulses traveling between the Mach-Zehnder type interferometers so that the phase of the substantially sinusoidal electrical modulation signals applied to the Mach-Zehnder type interferometers is synchronized with the phase of the series of optical pulses input to the Mach-Zehnder type interferometers.

34. An optical telecommunications system comprising:
at least one optical pulse generator comprising: at least two cascaded Mach-Zehnder type interferometers optically connected in series: each Mach-Zehnder-type interferometer comprising an optical input, an optical output, and an electrical input; the optical input of a successive Mach-Zehnder type interferometer being connected to the output of the immediately preceding Mach-Zehnder type interferometer in the series; a signal generator which, in use, produces a substantially sinusoidal electrical modulation signal for application to the electrical input of each of the Mach-Zehnder type interferometers, wherein the first Mach-Zehnder type interferometer is responsive to the substantially sinusoidal electrical modulation signal being applied to its electrical input, to generate a series of optical pulses having controllable chirp, and each successive Mach-Zehnder type interferometer is responsive to the substantially sinusoidal electrical modulation being applied to its electrical input, to shape the series of optical pulses that is input to the Mach-Zehnder type interferometer and produce an output train of optical pulses having a duty cycle that is dependent on the waveform of the electrical modulation signal being applied to at least one of the Mach-Zehnder type interferometers;
a data-gate for modulating the series of optical pulses being output by the pulse generator to produce an output of optical data pulses;
a receiver for receiving the optical data pulses output from the data-gate; and
a transmission channel connecting the data gate to the receiver and along which the optical data pulses propagate from the data-gate to the receiver.

35. An optical telecommunications system comprising:
at least one optical pulse generator comprising: a first Mach-Zehnder type interferometer comprising an optical output and an electrical input; a second Mach-Zehnder type interferometer comprising an optical input and an electrical input, the first and second Mach-Zehnder type interferometers being optically connected in series with the optical output of the first Mach-Zehnder type interferometer being connected to the optical input of the second Mach-Zehnder type interferometer; one of the first and the second Mach-Zehnder type interferometers has an optical path length shorter than the optical path length of the other Mach-Zehnder type interferometer; an electrical drive signal generator for applying substantially sinusoidal electrical modulation signals to the first and said second Mach-Zehnder type interferometer, wherein the first Mach-Zehnder type interferometer is responsive to the substantially sinusoidal electrical modulation signals being applied to its electrical input, to generate a series of optical pulses having substantially zero frequency chirp, and the second Mach-Zehnder type interferometer is responsive to the substantially sinusoidal electrical modulation signals being applied to its electrical input, to shape the series of optical pulses that is input to the second Mach-Zehnder type interferometer to produce an output train of optical pulses having a duty cycle that is dependent on the waveform of the electrical modulation signal being applied to at least one of the first and the second Mach-Zehnder type interferometer; and a phase adjuster operable to adjust the phase of the series of optical pulses traveling between the Mach-Zehnder type interferometers so that the phase of the substantially sinusoidal electrical modulation signals applied to the second Mach-Zehnder type interferometer is synchronized with the phase of the series of optical pulses input to the second Mach-Zehnder type interferometer;
a data-gate for modulating the series of optical pulses being output by the pulse generator to produce an output of optical data pulses;
a receiver for receiving the optical data pulses output from the data-gate; and
a transmission channel connecting the data-gate to the receiver and along which the optical data pulses propagate from the data-gate to the receiver.

36. An integrated chip comprising:
at least two cascaded Mach-Zehnder type interferometers optically connected in series:
each Mach-Zehnder type interferometer comprising an optical input, an optical output, and an electrical input; the optical input of a successive Mach-Zehnder type interferometer being connected to the output of a previous Mach-Zehnder type interferometer;
wherein the first Mach-Zehnder type interferometer is responsive to a substantially sinusoidal electrical modulation signal being applied to its electrical input, to generate a series of optical pulses having controllable chirp, and each successive Mach-Zehnder type interferometer is responsive to a substantially sinusoidal electrical modulation being applied to its electrical input, to shape the series of optical pulses that is input to the Mach-Zehnder type interferometer and produce an output train of optical pulses having a duty cycle that is dependent on the waveform of the electrical modulation signal being applied to at least one of the Mach-Zehnder-type interferometers.

37. An integrated chip according to claim 36, which is formed from Gallium Arsenide GaAs.
